(19) United States
(12) Patent Application Publication
(10) Pub. No.: US 2018/0270319 A1
(43) Pub. Date: Sep. 20, 2018

(54) NETWORK DEVICE, WIRELESS COMMUNICATION TERMINAL AND NON-TRANSITORY COMPUTER READABLE MEDIUM

(71) Applicant: Kabushiki Kaisha Toshiba, Minato-ku (JP)

(72) Inventors: Miyuki Ogura, Tachikawa (JP); Takeshi Ishihara, Yokohama (JP); Kensaku Yamaguchi, Kawasaki (JP)

(73) Assignee: Kabushiki Kaisha Toshiba, Minato-ku (JP)

(21) Appl. No.: 15/690,473

(22) Filed: Aug. 30, 2017

(30) Foreign Application Priority Data
Mar. 17, 2017 (JP) 2017-053241

(51) Int. Cl. H04L 29/08; H04W 28/26; H04W 8/18

(52) U.S. Cl. CPC H04L 67/2842; H04W 88/08; H04W 8/186; H04W 28/26

(57) ABSTRACT

According to one embodiment, a network device includes a receiver, a processor and a transmitter. The receiver receives a delivery reservation request of content from a first terminal in a coverage area of the network device. The processor selects a first network device from among a plurality of other network devices on the basis of the delivery reservation request, the other network devices being wirelessly communicable with terminals in respective coverage areas. The transmitter transmits a cache request to the first network device, the cache request instructing to acquire and cache the content from a content provision device. The transmitter transmits first information to the first terminal, the first information being information required to acquire the content from the first network device.

### CROSS REFERENCE TO RELATED APPLICATIONS

This application is based upon and claims the benefit of priority from the prior Japanese Patent Application No. 2017-053241, filed on Mar. 17, 2017, the entire contents of which are incorporated herein by reference.

### FIELD

Embodiments described herein relate to a network device, a wireless communication terminal and a non-transitory computer readable medium.

### BACKGROUND

Conventionally, there is a delivery system in which network nodes are provided with a cache server function and which generates an agent function of acquiring content from a host delivery server, in a network node to which a wireless communication terminal (hereinafter referred to as a terminal) is connected. In an environment in which the terminal is assumed to move, the terminal is not necessarily connected to the network node when the user wants to acquire content of the network node. Therefore, even if the terminal requests reservation delivery of content from the network node, there is a possibility that the content is not transmitted to the terminal, and the request is useless. Furthermore, accompanying movement of the terminal, the network node where the agent function is generated is changed, and this is a load to the network nodes.

Further, a communication network is known in which wireless access points are arranged in stores so that media content is delivered to mobile communication terminals. In this communication network, a reservation delivery service is provided for each of intermittent coverage areas by the plurality of wireless access points. This is service of delivering data from a cache of a wireless access point to all terminals which have entered the service area of the wireless access point, and it is not possible to perform data delivery depending on whether a delivery request is made by the mobile communication terminals or not.

### BRIEF DESCRIPTION OF THE DRAWINGS

FIG. 1 shows an overall configuration of a system according to a first embodiment;

FIG. 2 is a block diagram of a network device according to the first embodiment;

FIG. 3 is a diagram showing an example of a table;

FIGS. 4A and 4B are flowcharts showing operation examples of the first embodiment;

FIG. 5 is a sequence diagram of an operation according to the first embodiment;

FIGS. 6A and 6B are flowcharts showing other operation examples of the first embodiment;

FIG. 7 is a sequence diagram of another operation according to the first embodiment;

FIG. 8 is a block diagram of a terminal according to a second embodiment;

FIGS. 9A and 9B are flowcharts showing operation examples of the second embodiment;

FIG. 10 is a sequence diagram of an operation according to the second embodiment;

FIG. 11 is a block diagram showing a network configuration according to a third embodiment;

FIGS. 12A and 12B are diagrams showing other example of tables;

FIGS. 13A and 13B are flowcharts showing operation examples of the third embodiment;

FIG. 14 is a flowchart showing an operation example of the third embodiment;

FIGS. 15A and 15B are flowcharts showing operation examples of the third embodiment;

FIG. 16 is a sequence diagram of an operation according to the third embodiment;

FIGS. 17A and 17B are flowcharts showing operation examples of a fourth embodiment; and

FIG. 18 is a sequence diagram of an operation according to the fourth embodiment.

### DETAILED DESCRIPTION

According to one embodiment, a network device includes a receiver, a processor and a transmitter. The receiver receives a delivery reservation request of content from a first terminal in a coverage area of the network device. The processor selects a first network device from among a plurality of other network devices on the basis of the delivery reservation request, the other network devices being wirelessly communicable with terminals in respective coverage areas. The transmitter transmits a cache request to the first network device, the cache request instructing to acquire and cache the content from a content provision device. The transmitter transmits first information to the first terminal, the first information being information required to acquire the content from the first network device.

Embodiments of the present invention will be described below with reference to the drawings.

### First Embodiment

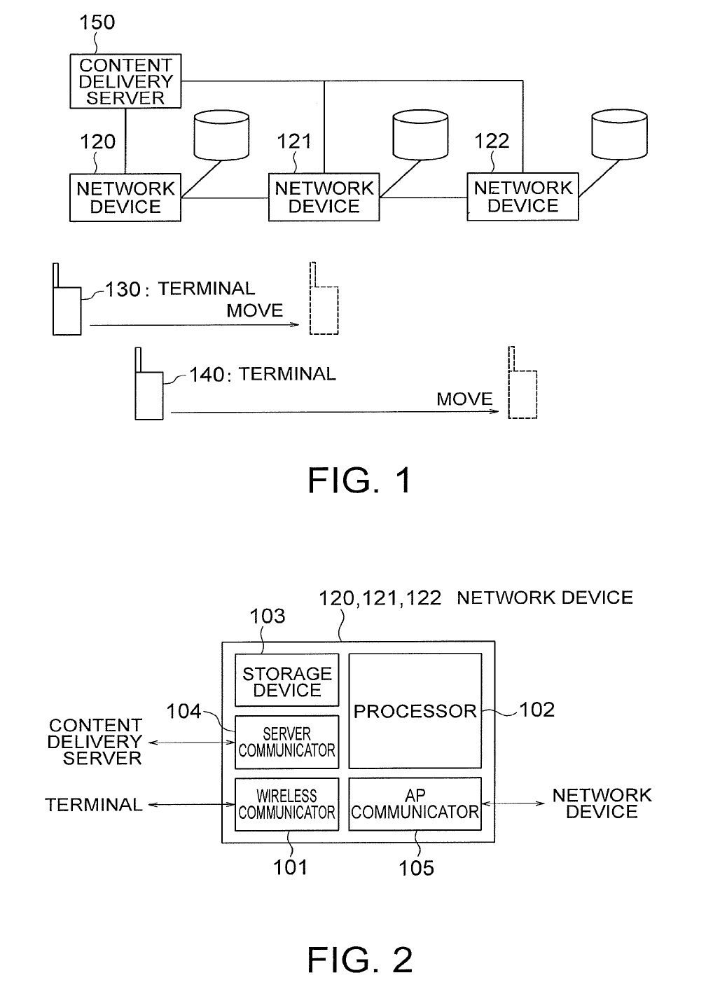

FIG. 1 shows an overall configuration of a system according to an embodiment of the present invention. This system is a wireless network system which delivers data of large content such as an image and a movie held in a content delivery server (a content provision device) 150 on a network such as the Internet, to wireless communication terminals (hereinafter referred to as terminals). More particularly, this system relates to avoiding an end user's inconvenience due to access concentration to the content delivery server, by downloading content requested by the end user (hereinafter referred to as the user) to a storage device provided in a network device (such as an access point) which is expected to be connected to by the terminal in the future and temporarily caching the content.

The system in FIG. 1 is provided with the content delivery server (the content provision device) 150, a plurality of network devices 120, 121 and 122 and terminals 130 and 140. The content delivery server 150 holds a plurality of pieces of content as data or information for delivery. Each of the network devices 120 to 122 is connected to the content delivery server 150 via a wired network, a wireless network or a hybrid of wired and wireless networks. In the present embodiment, a wired network is assumed. Further, the network devices 120 to 122 are connected to one another via a wired network, a wireless network or a hybrid of wired and wireless networks. In the present embodiment, a wired network is assumed. The network connecting between the content delivery server 150 and the network devices 120 to 122 and the network connecting the network devices 120 to 122 to one another may be different or the same.

Each of the network devices 120 to 122 is a wireless communication device provided with a cache function of caching content and a function of relaying a packet (which may be referred to as a frame). As an example, the network devices 120 to 122 are access points of a wireless LAN (Local Area Network), and the present embodiment assumes this case. Each of the network devices 120 to 122 has an area within which a wireless signal reaches from the device (a coverage area). Each of the network devices 120 to 122 forms a wireless communication group called BSS (Basic Service Set) with terminals in its coverage area and can perform wireless communication with the terminals belonging to the wireless communication group. FIG. 1 shows a situation in which the terminals 130 and 140 exist in the coverage area of the network device 120, and, after that, the terminals 130 and 140 move into the coverage areas of the network device 121 and the network device 122, respectively.

While existing in the coverage area of the network device 120, the terminals 130 and 140 transmit content delivery reservation requests to the network device 120. The content delivery reservation requests from the terminals 130 and 140 are transmitted at independent timings, respectively. The network device 120 decides a network device to be a content download destination (a cache destination) as a delivery destination network device for each of the terminals 130 and 140. In the example of FIG. 1, the network device 121 is decided for the terminal 130, and the network device 122 is decided for the terminal 140. As an example of a method for deciding a delivery destination network device, a network device having a coverage area through which a terminal is possibly going to pass (for example, a coverage area which includes a movement route of the terminal) may be identified. A specific operation example will be described later.

The network device 120 generates a request to cache the requested content (hereinafter referred to as a cache request) on the basis of the content delivery reservation request from the terminal 130 and transmits the cache request to the network device 121. The network device 120, which is a transmission source of the cache request, may be called a request source network device. Receiving the cache request, the network device 121 downloads the requested content from the content delivery server 150 and stores (caches) the downloaded content into a storage device of the network device 121 in association with an agent identifier described below. In particular, the network device 121 generates and activates an agent process (program) for the terminal 130 and performs downloading and caching of the content by the agent process. The agent identifier is an identifier assigned to an agent process. As an example, the agent identifier is an identifier having a unique value for each terminal/content pair. As for generating the agent identifier, the agent identifier may be generated by any of the network device 121 and by the network device 120. After the cached content is transmitted to the terminal by a procedure described below or after a predetermined timer expires, the agent process is deleted. The method for downloading content shown here is a mere example, and any other method is possible if content can be acquired and cached.

For the terminal 140, the network device 120 decides the network device 122 as a delivery destination network device and transmits a cache request. Receiving the cache request from the network device 120, the network device 122 activates an agent process, downloads the content from the content delivery server 150 and caches the downloaded content to a storage device of the network device 122 in association with an agent identifier.

After transmitting the content delivery reservation request, each of the terminals 130 and 140 receives the agent identifier from the network device 120 and stores the agent identifier into an internal storage device or a different storage device (such as a storage area of a processor). After that, the terminal 130 moves (actually, the user of the terminal 130 moves) and transmits a content delivery request including the agent identifier, in the coverage area of the network device 121. When receiving this request, the network device 121 identifies the content associated with the agent identifier, which is stored in the storage device provided in the network device 121, reads out the identified content from the storage device and transmits the content to the terminal 130. The terminal 140 also moves afterward and transmits a content delivery request including the agent identifier, in the coverage area of the network device 122. When receiving this request, the network device 122 identifies the content associated with the agent identifier in the storage device provided in the network device 122, reads out the identified content from the storage device and transmits the content to the terminal 140. At the time of moving into the coverage area of the network device 122, the terminal 140 does not have to pass through the coverage area of the network device 121. In the case of passing through the coverage area of the network device 121, the terminal 140 can transmit a content delivery request to the network device 121. In this case, however, since the network device 121 does not hold the content requested by the terminal 140, the network device 121 returns an error message showing that the network device 121 does not have the content.

The above is the summary of the present embodiment. The present embodiment will be described below in more detail.

FIG. 2 is a block diagram of the network device according to the first embodiment. All of the network devices 120, 121 and 122 have the configuration in FIG. 2. The network device in FIG. 2 is provided with a wireless communicator (a transmitter and a receiver) 101, a processor 102, a storage device 103, a server communicator (a first communicator) 104 and an AP communicator (a second communicator) 105.

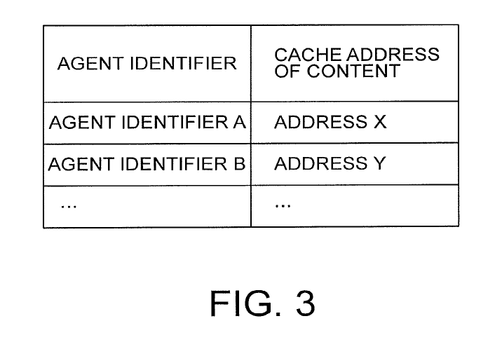

The wireless communicator 101 transmits/receives wireless signals to/from terminals. Specifically, the wireless communicator 101 transmits/receives wireless LAN frames. The AP communicator 105 transmits/receives predetermined signals to/from other network devices. Specifically, the AP communicator 105 transmits/receives frames in accordance with a used communication protocol. The server communicator 104 accesses the content delivery server 150 and downloads content requested by another network device or a terminal. The storage device 103 temporarily stores the downloaded content in association with an agent identifier. For example, as shown in FIG. 3, a table is prepared in which agent identifiers and addresses where pieces of content are stored (cache addresses) are mutually associated, and, thereby, the pieces of content are managed in association with the agent identifiers. This table may be managed in the storage device 103, an internal memory of the processor 102 or other storage devices.

The processor 102 controls the other block elements 101, and 103 to 105, and executes functions required to realize content delivery according to the present embodiment. As forms of an operation of the network device, there are an operation in a case corresponding to a request source network device and an operation in a case corresponding to a delivery destination network device.

As an operation example in the case of a request source network device, the processor 102 identifies, when receiving a content delivery reservation request from a terminal, at least one of other network devices to which content requested by the terminal is to be downloaded (to be cached). The processor 102 transmits a cache request including an identifier of the terminal (a terminal identifier) and an identifier of the content (a content identifier) to the identified network device (a delivery destination network device). The content identifier may be a character string such as a URL or may be a value of any other kind. In the present embodiment, a URL is assumed. The terminal identifier may be a MAC address of the terminal or may be an ID which the network device assigned to the terminal at the time of an association process (an association ID or the like). The processor 102 receives a response to the cache request (a cache response) from the delivery destination network device and transmits an agent identifier included in the cache response to the terminal.

As an operation example in the case of a delivery destination network device, the processor 102 internally generates, when receiving a cache request from another network device (a request source network device) by the AP communicator 105, an agent process for a terminal of a terminal identifier included in the cache request. A communication connection is established between the generated agent process and the content delivery server, and the agent process downloads content. The agent or the processor 102 holds the downloaded content in the storage device 103 in association with an agent identifier. The agent or the processor 102 generates the agent identifier on the basis of the terminal identifier and a content identifier. Otherwise, generating the agent identifier on the basis of one of the terminal identifier and the content identifier is also conceivable. The generated agent identifier may be encrypted by a hash function or the like. The processor 102 transmits a cache response including the agent identifier to the request source network device. After that, the processor 102 wirelessly connects to the terminal within its own coverage area after an association process and the like via the wireless communicator 101 to receive a content delivery request from the terminal. The processor 102 reads out content related with the agent identifier included in the content delivery request from the storage device 103 and transmits the read-out content to the terminal. If the appropriate content does not exist, the processor 102 returns an error message.

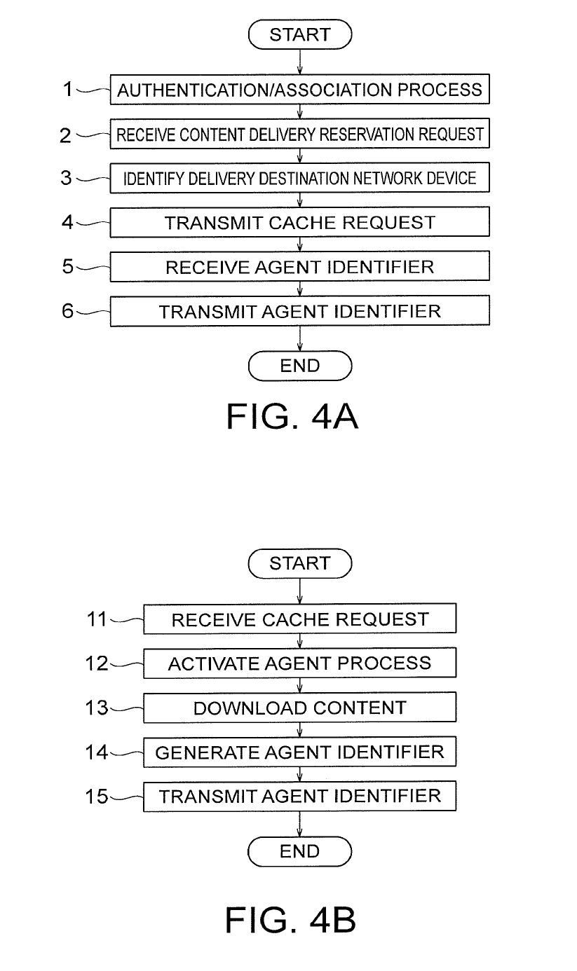

Next, an operation of the network device according to the first embodiment will be described with FIGS. 2 and 4. FIGS. 4A and 4B are flowcharts showing operations of the network device according to the first embodiment. FIG. 4A shows an operation of a network device which receives a content delivery reservation request from a terminal and transmits a cache request to another network device (a request source network device), and FIG. 4B shows an operation of a network device which receives the cache request from the request source network device and downloads content (a delivery destination network device).

As shown in FIG. 4A, the request source network device (assumed to be the network device 120 here) receives a connection request from a terminal first and performs authentication and association processes (step 1). In the present embodiment, since the network device 120 is a wireless LAN access point, the network device 120 performs the authentication process, an encryption process and the association process with the terminal in accordance with a wireless LAN protocol. Though the present embodiment assumes a case where the network device is an access point, the network device is not limited thereto. The terminal establishes a wireless connection (a wireless link) with the network device 120 by the procedure of step 1 and can belong to a BSS formed by the network device 120 (can connect to the local area network).

Next, the network device 120 receives a content delivery reservation request from the terminal via the wireless link established at step 1 (step 2). This request is realized by an HTTP application service or like in cooperation between the terminal and the network device 120. The network device 120 detects the content delivery reservation request by analyzing a wireless LAN frame received via the wireless communicator 101.

Next, the network device 120 selects (identifies) at least one network device (a delivery destination network device) which is to be caused to cache content requested by the terminal (step 3). The network device 120 grasps physical locations of the other network devices and a logical topology of the network devices in advance. This goes the same for the other network devices. A specific method for selecting the delivery destination network device is shown below as an example.

For example, device identifiers (SSIDs, MAC addresses or other identifiers are possible) of wireless LAN access points to which the terminal has connected in the past are held in association with time and route information as leaning information (action history information). The network device 120 selects a wireless LAN access point expected to be passed through by the terminal in the near future on the basis of times at which content delivery requests were made by the terminal (times at which the content delivery requests were received, transmission times included in the content delivery requests, or other times are possible) and information about places where the content delivery requests were made (pieces of location information about the network device 120 are possible, or pieces of GPS information may be received from the terminal). For example, in a case where a current location is included in route information in learning information, a route the user will follow from the current location as a starting point may be identified so as to identify at least one other network device the coverage area of which includes the identified route. In this case, a coverage area different from the current coverage area which the user enters first may be identified. Further, if the pair of reception time and current place corresponds to the learning information, it may be judged that the user acts in the same daily action pattern as usual and that the user will exist at a location corresponding to a predetermined time or at time after elapse of a predetermined time from the current time in the learning information, and a network device which includes the location in its coverage area may be identified. Further, if the user tends to stay at the same place for a certain time or more, a network device which includes the place in its coverage area may be identified. The learning information may be held in a local server not shown so that, at step 2, the network device 120 acquires the learning information through communication with the local server via the server communicator 104 or the AP communicator 105 immediately after receiving the content delivery reservation request. Otherwise, the learning information may be stored in the network device 120 in advance.

The delivery destination network device may be identified without using the learning information. For example, by calculating a movement direction and movement speed of the terminal (the user) from an arrival direction and reception time of a signal received from the terminal, a movement destination or movement destination range of the user may be identified. In the case of performing the process using the learning information described above, the movement direction and movement speed of the user may be additionally used. Further, it is also possible to register information about at least one delivery destination network device in the network device 120 in advance and identify the registered delivery destination network device.

Though it is assumed that the network device 120 identifies one delivery destination network device in the present example, it is also possible to identify two or more. In that case, the subsequent process is performed for each of the delivery destination network devices.

Next, the network device 120 establishes a communication link with the delivery destination network device identified at step 3 (for example, establishes a TCP/IP connection) and transmits a cache request to the delivery destination network device via the wired network (step 4). This cache request includes information required to activate a dedicated process (an agent process) for terminal for acquiring content, in the delivery destination network device. Examples include an identifier of the terminal and an identifier of the content.

The delivery destination network device receives the cache request from the request source network device (the network device 120) (step 11 of FIG. 4B) and internally activates an agent process for the terminal (step 12). This agent process is a program which operates inside the delivery destination network device. The agent process downloads the requested content from the content delivery server for the terminal (step 13).

The delivery destination network device generates an agent identifier for the agent process (step 14). As an example, the agent identifier is generated on the basis of a content identifier of the downloaded content and a terminal identifier. That is, in this case, the generated agent identifier has a value based on the content identifier and the terminal identifier. The delivery destination network device stores the downloaded content into the storage device 103 in association with the agent identifier. As a method for performing the association, the method like the table of FIG. 3 described before can be used as an example. This agent identifier is used to, at the time of transmitting the content held in the storage device 103 later, identify the content to be read out. Specifically, in the case of using the table of FIG. 3, a cache address is identified from the agent identifier, and the content is read out by accessing the identified cache address. Since each piece of content has a different agent identifier, the requested content can be easily identified even in a case where a plurality of pieces of content are cached for the same terminal.

The delivery destination network device transmits a cache response including the generated agent identifier, to the request source network device (the network device 120 in FIG. 1) via the AP communicator 105 (step 15).

Returning to FIG. 4A, the network device 120 receives the cache response transmitted by the delivery destination network device and detects the agent identifier (step 5). By receiving the cache response, the network device 120 recognizes that downloading (caching) has been completed in the delivery destination network device. The network device 120 generates a message including the agent identifier, for notifying that downloading of the content has been completed (a content acquisition completion message), and transmits the content acquisition completion message to the terminal (step 6).

The agent identifier generation method will be supplementarily described. As for an agent identifier, it is conceivable to use both of or any one of a content identifier and a terminal identifier or to additionally use information other than the identifiers. By generating an agent identifier on the basis of both of a content identifier and a terminal identifier, content can be cached and managed for each terminal. Further, it is possible to avoid the content from being downloaded by other terminals (that is, even if other terminals know the content identifier, they cannot download the content unless they know the terminal identifier). This effect can also be obtained in the case of generating an agent identifier by encrypting a content identifier by a hash function or the like. Further, in the case of generating an agent identifier only on the basis of a terminal identifier, it is possible to collectively download and store pieces of content for each terminal and collectively transmit the pieces of content to the terminal (in this case, even if the terminal transmits content delivery requests to the same network device at different timings, a plurality of pieces content are stored in association with the same agent identifier). Further, the timing of generating an agent identifier and the timing of transmitting the agent identifier to a terminal are not limited to the timings shown in FIG. 4B. Though an agent identifier is generated after downloading content in FIG. 4B, it is also possible to, when it is feared that delay of content delivery from the content delivery server 150 is large, generate an agent identifier after activation of an agent process, transmit a message including the generated agent identifier to a terminal, and download content later. In this case also, the agent identifier generation method described before is effective as it is, and the operations of the network devices (120, 121 and 122) are not influenced.

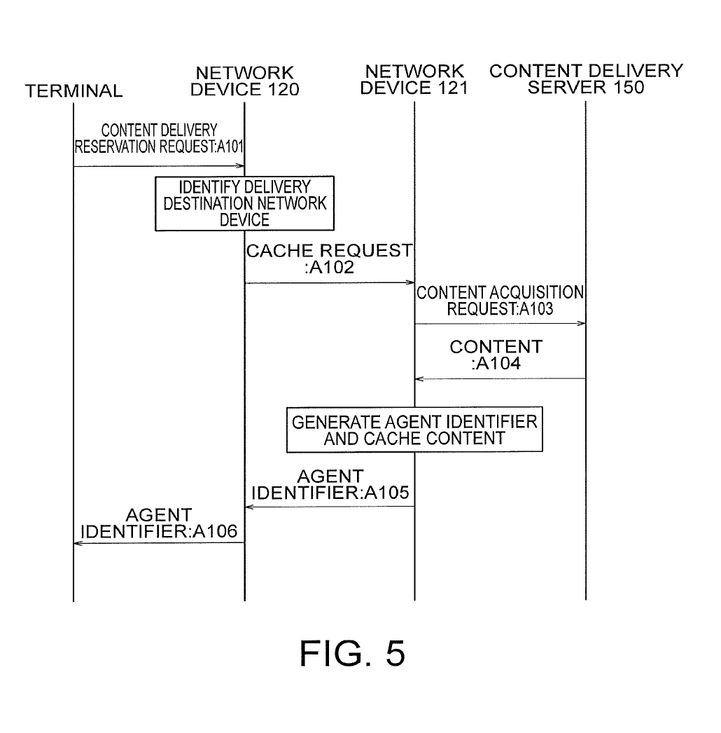

FIG. 5 shows an operation sequence of the system according to the present embodiment. A terminal transmits a content delivery reservation request to the network device 120 (A101), and the network device 120 identifies a delivery destination network device (the network device 121) on the basis of information about the terminal or the user. The network device 120 transmits a cache request to the network device 121 (A102), and the network device 121 downloads content from the content delivery server 150 (A103 and A104). The network device 121 generates an agent identifier on the basis of a content identifier and a terminal identifier and caches the downloaded content to the storage device 103 in association with the agent identifier. The network device 121 transmits a cache response including the agent identifier to the network device 120 (A105). The network device 120 detects the agent identifier included in the cache response and transmits a response (a reservation response) including the detected agent identifier to the terminal (A106). In FIG. 5, if it is feared that download of the content from the content delivery server 150 (A104) is delayed, the network device 121 can generate an agent identifier and transmit the agent identifier to the network device 120 prior to download.

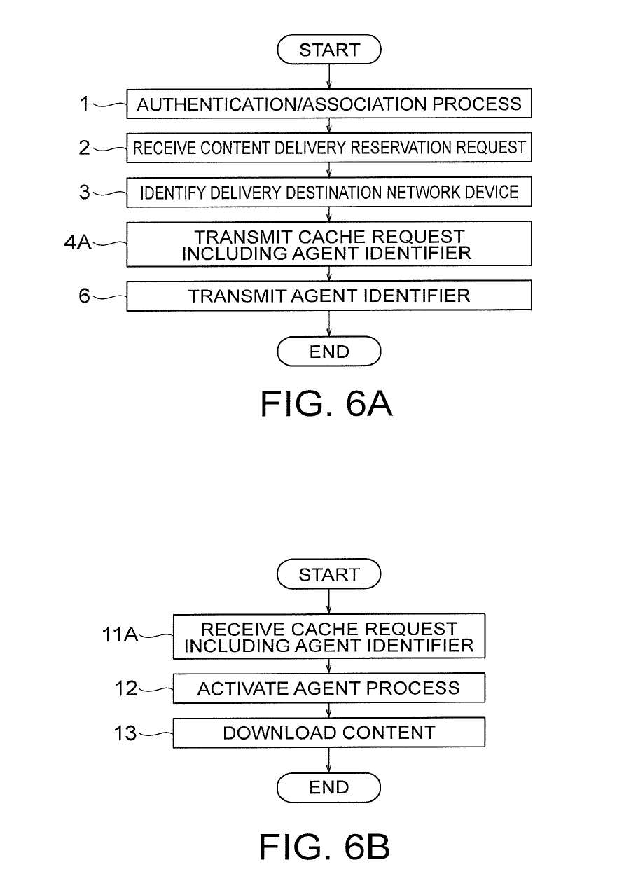

Though a delivery destination network device generates an agent identifier in the embodiment described above, a request source network device may generate the agent identifier. Flowcharts of operations performed in this case are shown in FIGS. 6A and 6B. The same steps as steps of the flowcharts of FIGS. 4A and 4B will be given the same step numbers, and description of the same operations will be omitted.

After identifying a delivery destination network device, a request source network device (the network device 120 here) generates an agent identifier and transmits a cache request including the agent identifier and the like to the delivery destination network device (step 4A). Further, the request source network device also transmits the agent identifier to a terminal which has transmitted a content delivery reservation request (step 6).

The delivery destination network device receives the cache request including the agent identifier and the like from the request source network device (step 11A), activates an agent process (step 12), downloads content (step 13) and stores the content into the storage device 103 in associate with the agent identifier. After that, the delivery destination network device may transmit a cache response for making a notification to the effect that download of the content has been completed, to the request source network device. The agent identifier may be included or may not be included in the cache response.

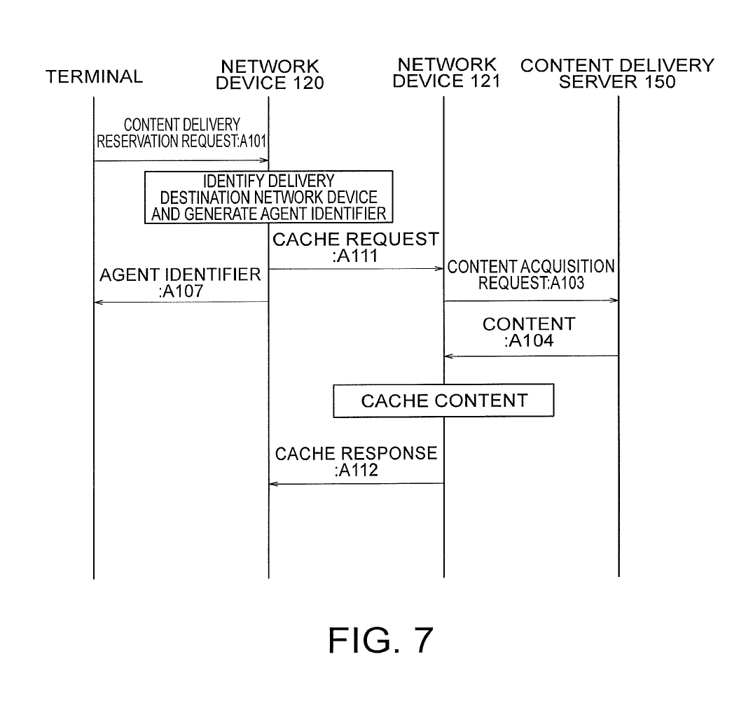

FIG. 7 shows an operation sequence of the system in the case of an agent identifier being generated by a request source network device. A terminal transmits a content delivery reservation request to the network device 120 (A101); and the network device 120 identifies a delivery destination network device (the network device 121) on the basis of information about the terminal or the user and generates an agent identifier on the basis of a content identifier of requested content and a terminal identifier. The network device 120 transmits a cache request including the agent identifier to the network device 121 (A111) and transmits a reservation response including the agent identifier to the terminal (A107). The network device 121 downloads content from the content delivery server 150 (A103 and A104). The network device 121 caches the downloaded content to the storage device 103 in association with the agent identifier. The network device 121 returns a cache response notifying completion of download of the content to the network device 120 (A112).

In the present embodiment, a delivery destination network device acquires content from the content delivery server 150. As another method, however, a request source network device may acquire content from the content delivery server 150 and provide the acquired content to a delivery destination network device. The same goes for other embodiments described below. In the case where a request source network device acquires and transfers content as described above, there is a problem that traffic between the request source network device and a delivery destination network device increases. However, even in a situation in which communication is temporarily difficult between the delivery destination network device and the content delivery server 150, content can be delivered to a terminal without any trouble.

As described above, according to the present embodiment, a request source network device which has received a content delivery reservation request from a terminal decides a delivery destination network device which downloads (caches) content, and the delivery destination network device activates an agent process which is software for performing a process of downloading and storing content. The agent process downloads the content from the content delivery server 150 and stores the content into the storage device 103 in association with an agent identifier. Thereby, it becomes possible to download content requested by a terminal to a network device expected to be connected to by the terminal in the future before the terminal connects to the network device (that is, offline). That is, at a stage where an authentication procedure with the terminal has not been performed yet, the delivery destination network device can download the content requested by the terminal and cache the content to the storage device 103 in advance. This is on the assumption that a plurality of network devices according to the present embodiment have been mutually authenticated in advance, or the plurality of network devices are devices constructed under some trust relationship. Further, by generating an agent identifier on the basis of a terminal identifier and a content identifier, it is possible to avoid a terminal other than a terminal which has made a delivery reservation request from downloading content from a delivery destination network device.

Further, in a case where a plurality of delivery destination network devices, by an agent identifier generation algorithm common to the delivery destination network devices being used when the delivery destination network device generating an agent identifier (in the case of the operations of FIGS. 4A and 4B), a terminal can use the same agent identifier at the time of actually downloading content from any of the delivery destination network devices. Therefore, it is possible for the terminal to avoid complexity of managing a plurality of agent identifiers. In the case where a request source network device generates an agent identifier (in the case of FIGS. 6A and 6B), this problem can be avoided by the request source network device generating one agent identifier irrespective of the number of delivery destination network devices.

### Second Embodiment

In the first embodiment, mainly a configuration of a network device and an operation of the network device performed after receiving a content delivery reservation request from a terminal until downloading and caching the requested content have been shown. In the present embodiment, a configuration and operation of a terminal, and an operation of a network device receiving a content delivery request from the terminal and transmitting content to the terminal will be described in detail.

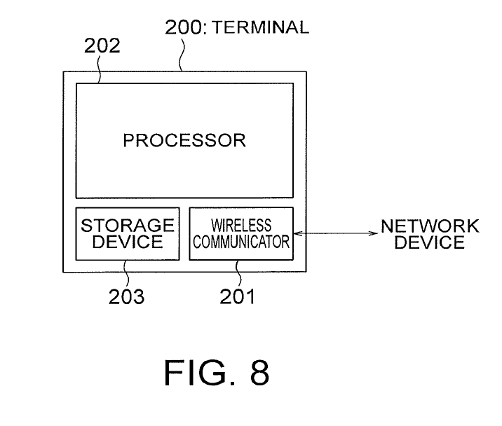

FIG. 8 is a block diagram of the terminal according to the present embodiment. A block diagram of the network device is the same as FIG. 2.

A terminal 200 is provided with a wireless communicator (a transmitter and a receiver) 201, a processor 202 and a storage device 203. The wireless communicator 201 performs transmission/reception of wireless signals to/from a network device. Specifically, the wireless communicator 201 performs transmission/reception of wireless LAN frames. The storage device 203 holds content received from a delivery destination network device and data or information required to execute an operation according to the present embodiment. The processor 202 performs a process for wireless communication and various processes related to reception of content.

As examples of processes by the processor 202, there are a process for detecting a network device with which its own terminal can communicate, a process for transmitting a content delivery reservation request about content to be acquired, to a request source network device (the network device 120 in FIG. 1), a process for receiving an agent identifier from the request source network device, a process for transmitting a content delivery request including the agent identifier to a network device of a movement destination coverage area (a delivery destination network device), and a process for receiving content corresponding to the agent identifier from the delivery destination network device and storing (caching) the received content into the storage device 203 and reproducing the content.

On the other hand, the processor 102 of the network device reads out appropriate content from the storage device 103 on the basis of an agent identifier included in a content delivery request received from a terminal and transmits data of the read-out content to the terminal. Actually, the content is transmitted in a wireless LAN frame. If the content corresponding to the agent identifier does not exist, the processor 102 transmits an error message to the terminal.

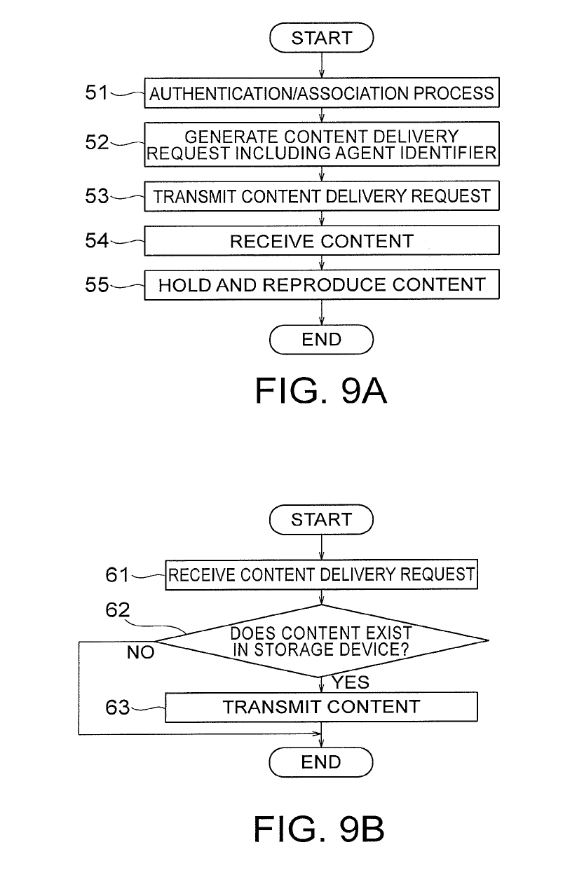

The operations of the terminal and network device (a delivery destination network device) according to the present embodiment will be described with FIGS. 8 and 9. FIG. 9A shows a flowchart of the operation of the terminal according to the second embodiment, and FIG. 9B shows a flowchart of the operation of the network device.

After the terminal receives an agent identifier from a request source network device (the network device 120 in FIG. 1), the user moves, and the terminal detects a network device at a movement destination and transmits a connection request (step 51). For example, the terminal detects the network device by receiving beacon frames the network device (a wireless LAN access point) intermittently transmits. By performing an authentication process, an encryption process and an association process with the detected network device, the terminal wirelessly connects to the network device (the same step 51).

The terminal generates a content delivery request including an agent identifier acquired in advance (step 52). As an example, an address of the network device is set in a field of a reception destination address of a frame of the content delivery request.

The terminal transmits the content delivery request including the agent identifier to the wirelessly connected network device (step 53).

As shown in FIG. 9B, the network device receives the content delivery request transmitted from the terminal and extracts the agent identifier included in the content delivery request (step 61).

The network device judges whether or not content associated with the extracted agent identifier exists in the storage device 103 the network device is provided with (step 62). If the content exists (step 62: YES), the network device reads out the content from the storage device 103 and transmits the content to the terminal (step 63). As a specific operation example, the network device transfers data of the content read out from the storage device 103 to a RAM of the processor 102, generates a frame to be transmitted to the terminal, from the data stored in the RAM, and transmits the generated frame. The network device may delete the content the transmission of which has been completed.

If the content associated with the extracted agent identifier does not exist (step 62: NO), the network device transmits an error message to the terminal and ends the process.

The terminal receives the content transmitted from the network device (step 54 of FIG. 9A) and holds the received content in the storage device 203 (step 55). The terminal reproduces the content held in the storage device 203. Thereby, the user of the terminal can view the content held in the storage device 203 offline (without connecting to the network).

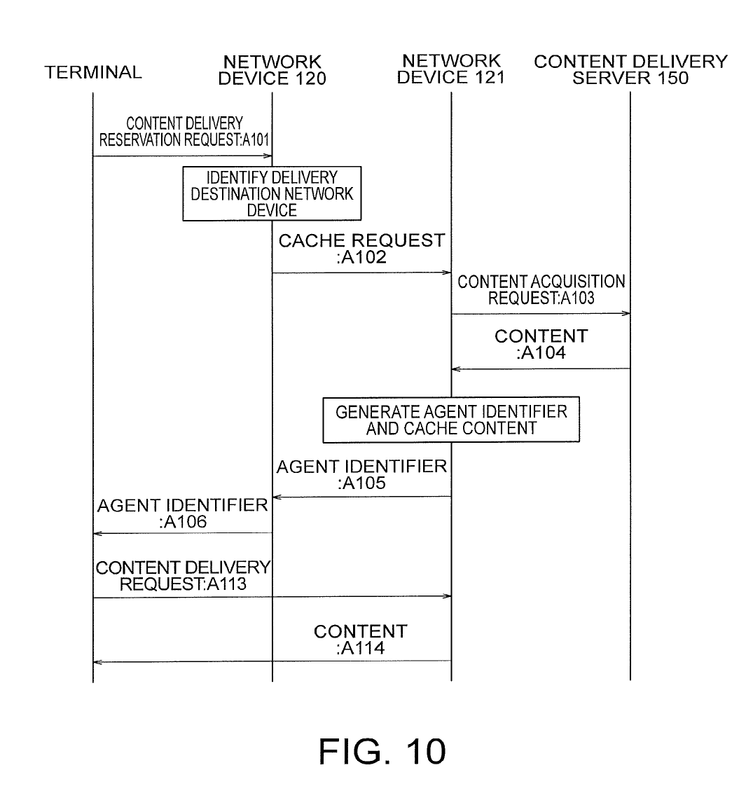

FIG. 10 shows an operation sequence according to the present embodiment. A sequence until a terminal acquires an agent identifier (step A101 to A106) is the same as FIG. 5. The terminal receives the agent identifier. After wirelessly connecting to another network device (the network device 121 here), the terminal transmits a content delivery request including the agent identifier to the network device 121 (A113). The network device 121 reads out content requested by the terminal from the storage device 103 and transmits the content to the terminal (A114). It is also possible to add similar steps A112 and A113 to the sequence shown in FIG. 7, which has been described before.

### Third Embodiment

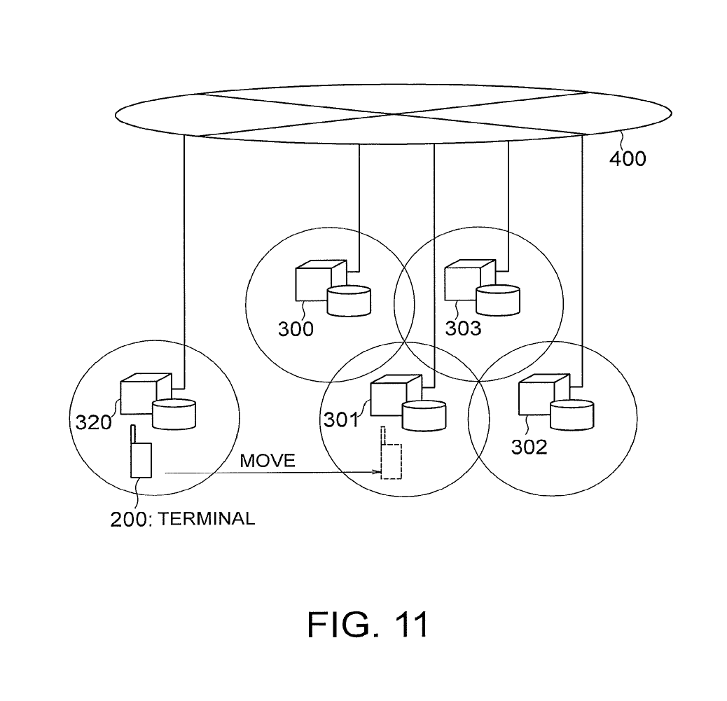

A summary of the present embodiment will be described with FIG. 11. FIG. 11 shows a network configuration according to the present embodiment.

Network devices 320, 300, 301, 302 and 303 are connected to one another via a wired or wireless network 400. Here, the network 400 is assumed to be a wired network. Circles surrounding the network devices in FIG. 11 indicate coverage areas. The terminal 200 exists in the coverage areas of the network device 320. When the terminal 200 transmits a content delivery reservation request to the network device 320, the network device 320 identifies the network device 300 as a delivery destination network device and further identifies the network devices 301, 302 and 303 located around the network device 300 (peripheral network devices). The network device 320 is provided with network configuration information showing peripheral network devices around each network device in advance and identifies the peripheral network devices around the network device 300 on the basis of the network configuration information. Here, “peripheral” means that a physical distance or a distance on a network is short.

The network device 320 assigns a common group identifier to the delivery destination network device 300 and the peripheral network devices 301 to 303. Though a group identification number is assigned as the group identifier here, the group identifier is not limited to a number. Then, the network device 320 transmits a cache request including a set of device identifiers (network device addresses here) of network devices 300 to 303 to which the same group identification number is assigned (hereinafter referred to as an address set) and a group identification number, to the delivery destination network device 300. Further, to each of the peripheral network devices 301 to 303, the network device 320 transmits a registration request including the address set and the group identification number.

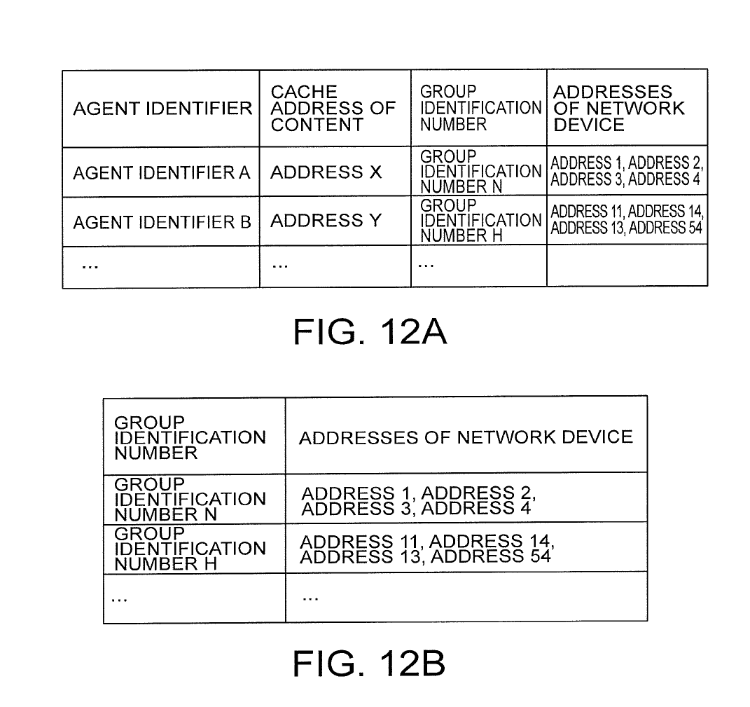

In response to the cache request, the delivery destination network device 300 downloads content and stores the content into its storage device in association with an agent identifier and the group identification number, similarly to the embodiments described above. At this time, the content may be stored by further associating the address set with the group identification number. As an example, a table may be used in which agent identifiers, cache addresses of content, group identification numbers and address sets (each including addresses of network devices) are mutually associated as shown in FIG. 12A.

In response to the registration request, the peripheral network devices 301 to 303 store the group identification number and the address set into their storage devices or other storage devices in association with each other. As an example, a table may be used in which group identification numbers and address sets are mutually associated as shown in FIG. 12B. A value discriminating a delivery destination network device from other network devices (a type value) may be added to each address included in the address sets. In this case, the request source network device 320 transmits a registration request in which type values are added to addresses.

It is assumed that the terminal 200 moves and enters the coverage area of the network device 301. The terminal 200 wirelessly connects to the network device 301 and transmits a content delivery request including the group identification number and the agent identifier to the network device 301. The network device 301 judges whether content corresponding to the agent identifier exists in its storage device or not. If the content does not exist, the network device 301 identifies network devices having the same group identification number, and transmits an inquiry message about whether the content corresponding to the agent is held or not, to the identified network devices. Here, the network device 300 holds the content corresponding to the agent identifier. Therefore, the network device 301 acquires the content from the network device 300 and transmits the acquired content to the terminal 200. When type values are added to addresses, a network device holding the content (that is, a delivery destination network device) may be identified using the type values. Thereby, it is necessary to make the inquiry only once, and the content can be efficiently acquired.

The above is the summary of the present embodiment. The present embodiment will be described below in more detail.

Though a block diagram of a network device of the present embodiment is the same as FIG. 2 described before, operations of the processor 102 and the like are partially changed or extended. Further, though a block diagram of a terminal of the present embodiment is the same as FIG. 8 described before, operations of the processor 202 and the like are partially changed or extended. A description will be made below mainly on operations different from operations in the first and second embodiments.

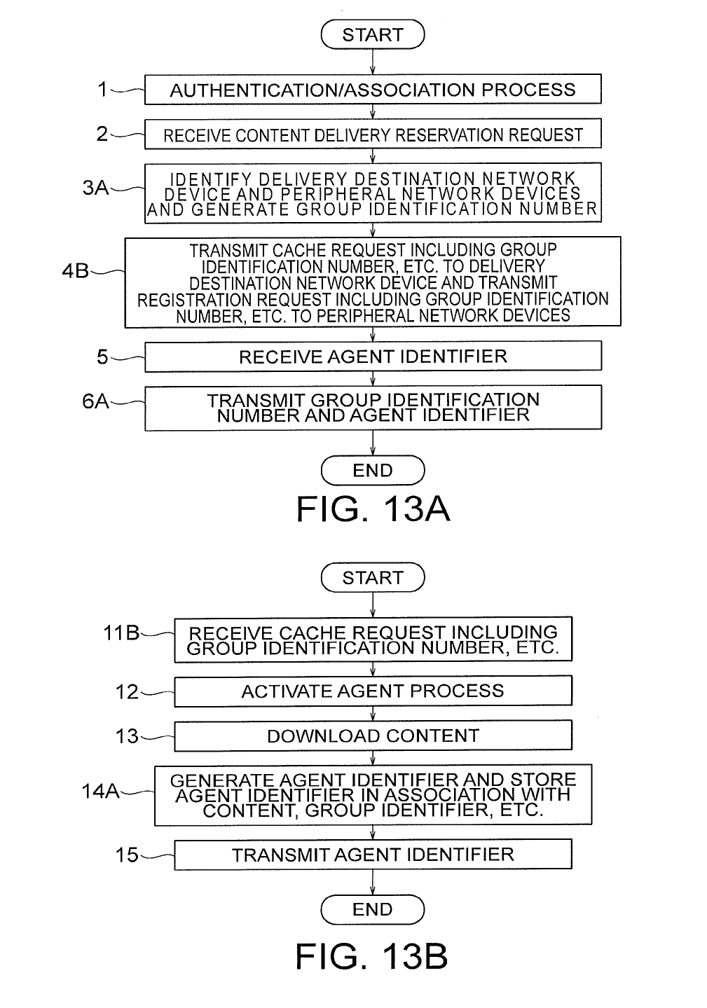

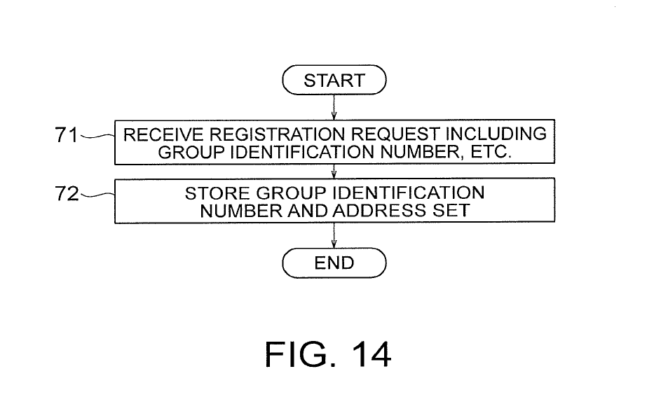

FIG. 13A is a flowchart of an operation of a network device which receives a network delivery reservation request from the terminal 200 (a request source network device). FIG. 13B is a flowchart of an operation of a delivery destination network device. FIG. 14 is a flowchart of an operation of peripheral network devises.

When receiving a content delivery reservation request from the terminal 200 which has wirelessly connected (steps 1 and 2), a request source network device (the network device 320 here) identifies a delivery destination network device (the network device 300 here) and a peripheral network device (the peripheral network devices 301 to 303 here) (step 3A). Then, the request source network device 320 generates a group identification number common to the network devices 320, and 300 to 303 (the same step 3A).

The request source network device 320 transmits a cache request including an address set of the network devices 300 to 303 and the group identification number to the delivery destination network device 300 (step 4B). Further, the network device 320 transmits a registration request including the address set and the group identification number to each of the peripheral network devices 301 to 303 (the same step 4B).

As shown in FIG. 13B, the delivery destination network device 300 receives the cache request from the request source network device 320 (step 11B). The delivery destination network device 300 activates an agent process (step 12) and downloads content using the agent process (step 13). The delivery destination network device 300 generates an agent identifier and stores the downloaded content into its storage device in association with the agent identifier and the group identification number (step 14A). The address set may be associated with the group identification number. The network device 300 transmits a cache response including the agent identifier to the request source network device 320. As for the steps of FIG. 13B, it is possible to divide one step into a plurality of steps and change order of the steps unless the object of the present invention is damaged. For example, when it is feared that delay of content delivery from the content delivery server 150 is large, it is possible to generate a group identifier as well as generating an agent identifier, after activating an agent process, and, later, store content in association with the agent identifier and the group identifier after download of the content is completed.

On the other hand, as shown in FIG. 14, each of the peripheral network devices 301 to 303 receives the registration request from the request source network device 320 (step 71). Each of the peripheral network devices 301 to 303 stores the group identification number and the address set of the network devices 300 to 303 into its storage device or another storage device in association with each other (step 72).

Returning to FIG. 13A, the request source network device 320 receives the cache response including the agent identifier from the delivery destination network device 300 (step 5). The request source network device 320 transmits a reservation response including the agent identifier and the group identification number generated at step 3A to the terminal 200 (step 6A).

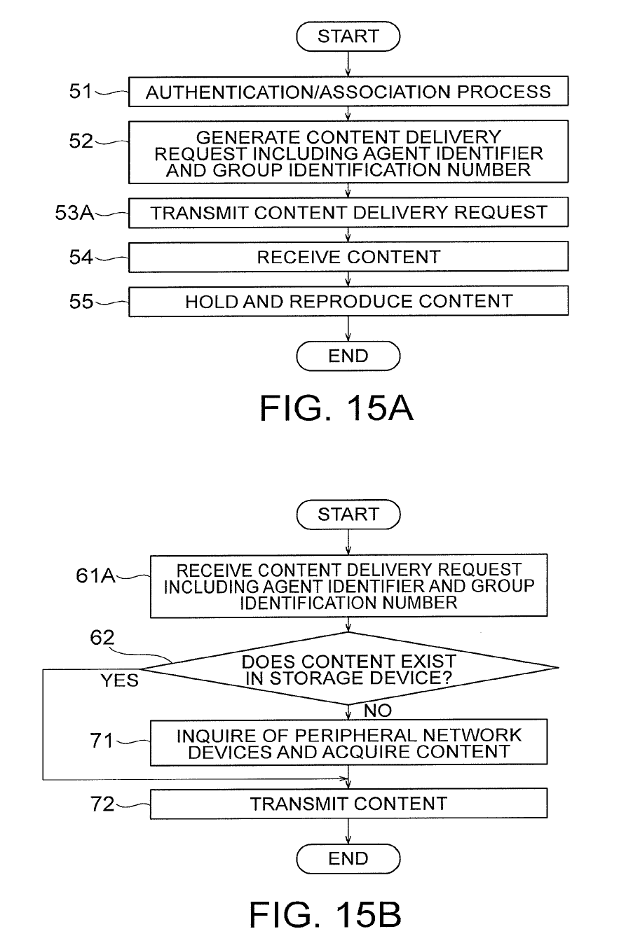

FIG. 15A is a flowchart of an operation in a case where the terminal 200 makes a content delivery request to a network device of a coverage area of a movement destination. FIG. 15B is a flowchart of an operation of the network device which has received the content delivery request.

As shown in FIG. 15A, the terminal 200 wirelessly connects to the network device by performing an authentication/association process with the network device (step 51). Then, the terminal 200 generates a content delivery request including an agent identifier and a group identification number (step 52) and transmits the generated content delivery request to the network device (step 53A).

As shown in FIG. 15B, the network device receives the content delivery request (step 61A) and judges whether content corresponding to the agent identifier included in the content delivery request exists in its storage device (step 62). If the content exists (YES), the network device reads out the content from the storage device and transmits the content to the terminal 200 (step 72). If the content does not exist (NO), the network device transmits an inquiry message to each of the peripheral network devices on the basis of the group identification number to confirm whether the peripheral network device holds the content corresponding to the agent identifier (step 71). In the example of FIG. 11 described before, the network device which has received the content delivery request is the network device 301, and the network device 301 asks the network devices 300, 302 and 303 because the network device 301 does not hold the content. Since the network device 300 holds the content, the network device 301 establishes a secure connection with the network device 300 and acquires the content from the network device 300 via the connection. The network device which has acquired the content transmits the acquired content to the terminal 200 (step 72).

Returning to FIG. 15A, the terminal 200 receives the content from the network device to which the terminal 200 transmitted the content delivery request (step 54). This content is content held by the network device or content held by another network device belonging to a group with the same group identification number as the network device. The terminal 200 stores the received content into its storage device and reproduces the content so that the user can view (step 55).

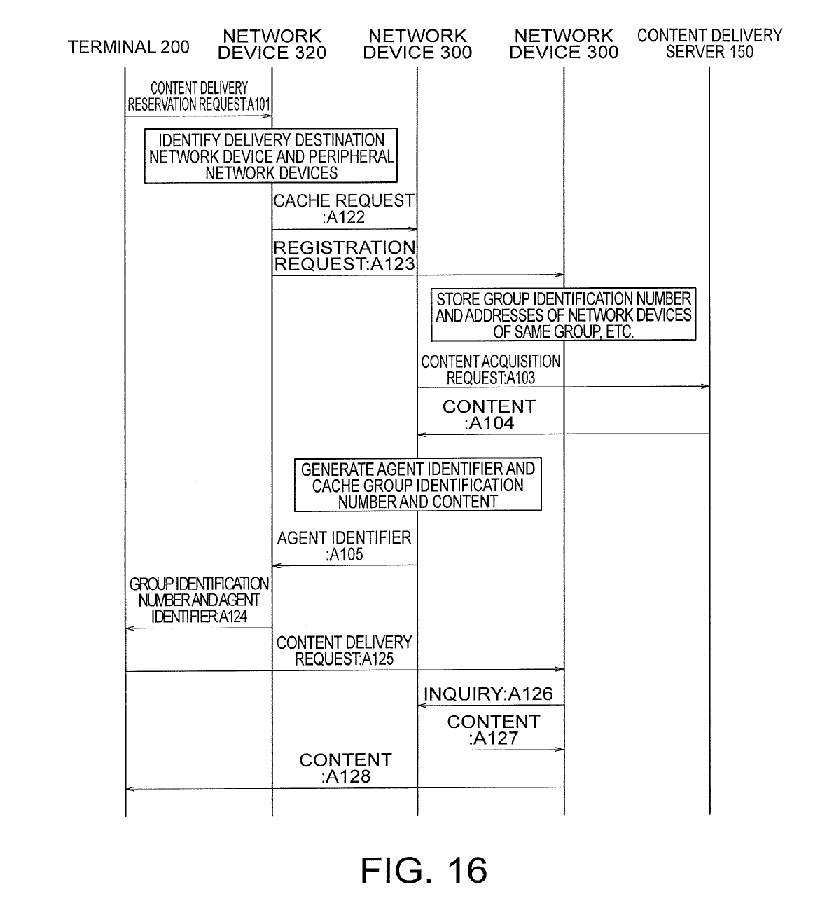

FIG. 16 shows an operation sequence of a system according to the present embodiment. The terminal 200 transmits a content delivery reservation request to the network device 320 (A101), and the network device 320 identifies a delivery destination network device (the network device 300) and peripheral network devices (the peripheral network devices 301 to 303) on the basis of information about the terminal 200 or the user. The network device 320 transmits a cache request including a content identifier, a group identification number, an address set of the network devices 300 to 303 and the like to the delivery destination network device 300 (A122). Further, to each of the peripheral network devices 301 to 303, the network device 320 transmits a registration request including the group identification number, the address set and the like (A123). In FIG. 16, only the peripheral network device 301 among the peripheral network devices 301 to 303 is shown for simplification of representation.

Each of the peripheral network devices 301 to 303 stores the group identification number and the address set included in the registration request into a storage device such as its own storage device. After storing the group identification number and the address set, each of the peripheral network devices 301 to 303 may transmit a registration response to the network device 320 (not shown).

When receiving the cache request, the delivery destination network device 300 activates an agent process and downloads requested content from the content delivery server 150 (A103 and A104). The delivery destination network device 300 generates an agent identifier on the basis of the content identifier and the like and stores the downloaded content into its storage device in association with the agent identifier and the group identification number. The delivery destination network device 300 may further store the address set. If it is feared that download of the content from the content delivery server 150 (A104) is delayed, the network device 300 can generate the agent identifier prior to download and transmit the agent identifier to the network device 320.

The delivery destination network device 300 transmits a cache response including the agent identifier to the network device 320 (A105). The network device 320 transmits a reservation response including the agent identifier and the group identification number to the terminal 200 (step A124).

After the user moves, and the terminal 200 connects to another network device (the peripheral network device 301 here), the terminal 200 transmits a content delivery request including the agent identifier and the group identification number to the network device 301 (A125). Since the network device 301 does not hold the content requested by the terminal 200, the network device 301 inquires of a network device corresponding to each address included in an address set corresponding to the group identification number whether the network device holds content corresponding to the agent identifier (A126). Here, since the network device 300 holds the content, the content is acquired from the network device 300 (A127). The network device 301 transmits the content to the terminal 200 (A128). The network device 301 may store the content acquired from the network device 320 into the storage device the network device 301 is provided with in association with the agent identifier. Thereby, if acquisition of the same content is requested by the terminal 200 again, the content can be provided to the terminal at a high speed.

As described above, according to the present embodiment, even if a network device located in a coverage area into which a terminal has moved does not hold content, the network device acquires the content from another network device having the same group identification number and transfers the content to the terminal. Thereby, even when a terminal belongs to an area different from a coverage area of a delivery destination network device because of movement of the user, the terminal can receive content.

### Fourth Embodiment

The present embodiment is an embodiment obtained by modifying a part of the third embodiment. In the present embodiment, the processor 102 of each of the network devices (the peripheral network devices 301 to 303 in FIG. 11) which have received a group identification number from a request source network device (the network device 320 in FIG. 11) informs information including a group identification number by a wireless signal via the wireless communicator 101. For example, the group identification number may be informed by a beacon frame which is transmitted intermittently (for example, at predetermined time intervals) or may be informed by a separate frame (for example, a dedicated frame).

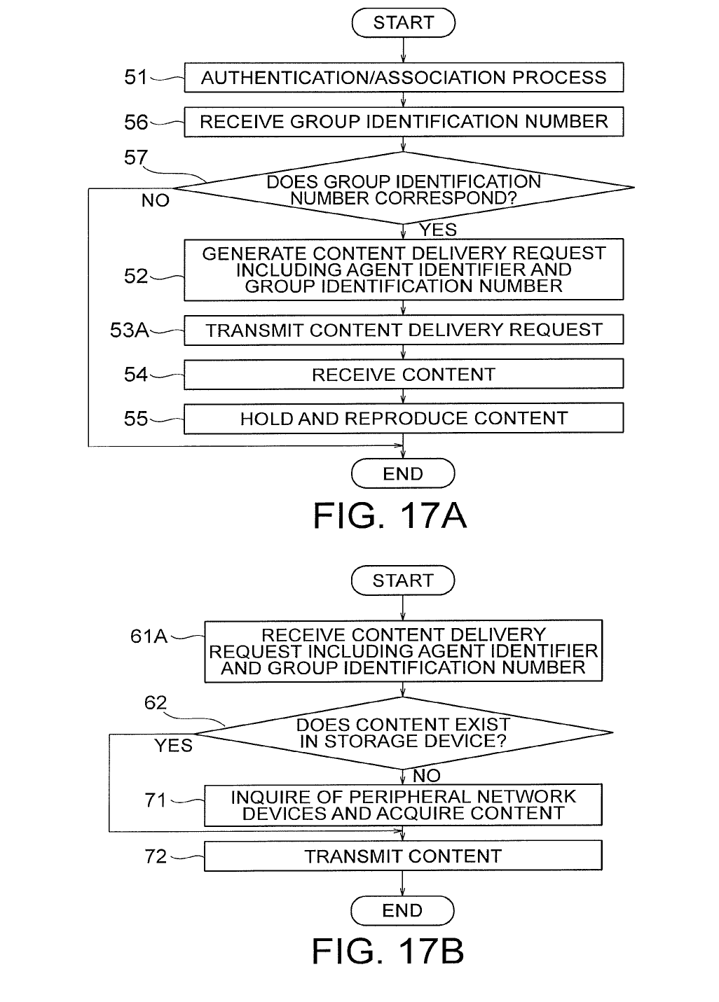

FIG. 17A is a flowchart of an operation performed in a case where the terminal 200 which has received an agent identifier and a group identification number enters a different coverage area because of the user's movement, wirelessly connects to a network device of the coverage area and transmits a content delivery request. FIG. 17B is a flowchart of an operation performed when the network device receives the content delivery request from the terminal 200. FIG. 17B is the same as FIG. 15B.

It is assumed that the terminal 200 has received the group identification number and the agent identifier from a request source network device. After that, the terminal 200 wirelessly connects to the network device of the movement destination by performing an authentication/association process with the network device (step 51) and receives a group identification number which the network device informs (step 56). The terminal 200 judges whether the received group identification number corresponds to the group identification number the terminal 200 holds (step 57). If the group identification number does not correspond (NO), the terminal 200 judges that content cannot be acquired in the current coverage and ends the process. If the group identification number corresponds (YES), the terminal 200 performs the same operation as shown in the third embodiment. That is, the terminal 200 generates a content delivery request including the agent identifier and the group identification number and transmits the generated content delivery request to the network device (steps 52 and 53A). The terminal 200 receives the content from the network device which is the transmission destination of the content delivery request (step 54). The terminal 200 holds the received content and reproduces the content so that the user can view.

On the other hand, an operation of the network device which has received the content delivery request from the terminal 200 is the same as shown in the third embodiment. That is, as shown in FIG. 17B, the network device receives the content delivery request (step 61A) and judges whether content corresponding to the agent identifier transmitted from the terminal 200 exists in its storage device (step 62). If the content exists (YES), the network device reads out the content from the storage device and transmits the content to the terminal 200 (step 72). If the content does not exist (NO), the network device confirms, by transmitting an inquiry message to each of the peripheral network devices on the basis of the group identification number, whether the peripheral network device holds the content corresponding to the agent identifier (step 71). The network device acquires the content from a peripheral network device that holds the content. The network device which has acquired the content transmits the acquired content to the terminal 200 (step 72).

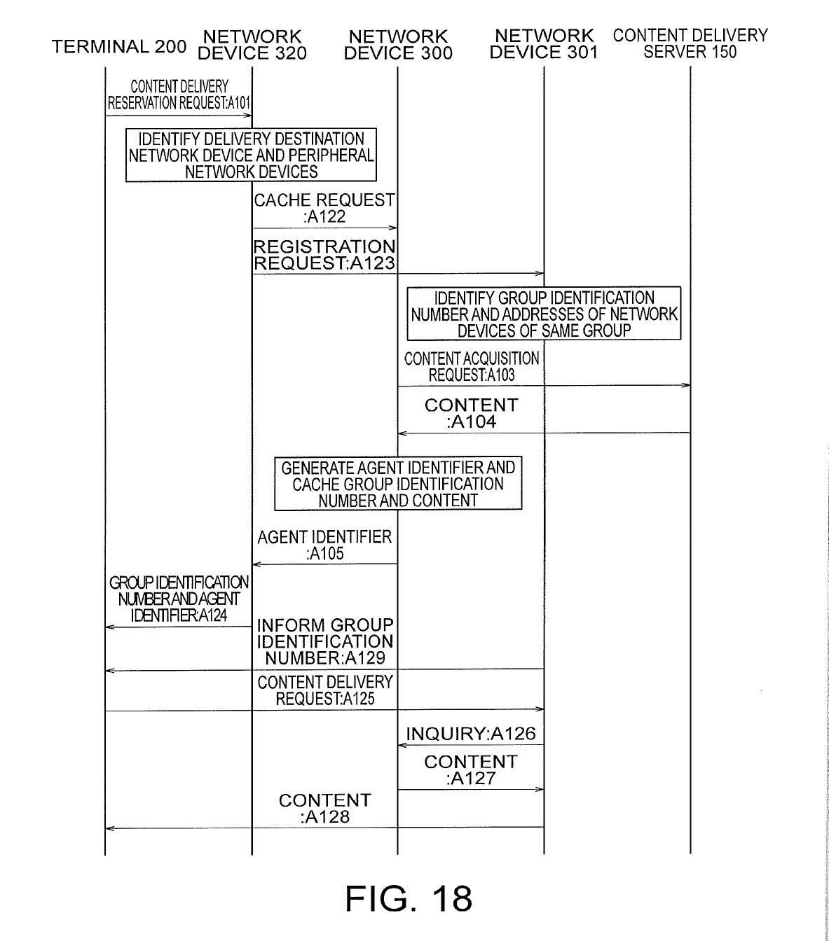

FIG. 18 shows an operation sequence of a system according to the present embodiment. Step A129 of a network device informing a group identification number is added to the sequence of FIG. 16 described before. Though the network device 301 informs a group identification number in FIG. 18, the network devices 300, 302 and 303 also inform the group identification number actually. When detecting that the received group identification number corresponds to a group identification number the terminal 200 holds, the terminal 200 transmits a content delivery request (A125).

As described above, according to the present embodiment, since a terminal can judge in advance whether the terminal can acquire content in a coverage area where the terminal is currently located, the terminal can efficiently make a content delivery request. That is, an unnecessary signal is not transmitted, and an effect of reduction in power consumption of the terminal is obtained.

The agent identifier and the group identification number in any of the embodiments described above may be a mere numerical value or may be a character string such as a domain name. Further, in order to enhance safety, a calculated value of a hash function which has been calculated with a numerical value, a character string or the like as an input is also possible.

The network device and the terminal in each embodiment may also be realized using a general-purpose computer device as basic hardware. For example, generation and activation of an agent process, downloading and caching of content by the agent process, and deliver control of the cached content to the terminal can be realized by causing a processor mounted in the above described computer device to execute a program. In this case, the network device and the terminal may be realized by installing the above described program in the computer device beforehand or may be realized by storing the program in a storage medium such as a CD-ROM or distributing the above described program over a network and installing this program in the computer device as appropriate. Furthermore, the caching of the content may also be realized using a memory device or hard disk incorporated in or externally added to the above described computer device or a storage medium such as CD-R, CD-RW, DVD-RAM, DVD-R as appropriate.

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, or one or more microprocessors in conjunction with a DSP core.

As another example, the term “memory” may encompass any electronic component which can store electronic information. The “memory” may refer to various types of media such as a random access memory (RAM), a read-only memory (ROM), a programmable read-only memory (PROM), an erasable programmable read only memory (EPROM), an electrically erasable PROM (EEPROM), a non-volatile random access memory (NVRAM), a flash memory, and a magnetic or optical data storage, which are readable by a processor. It can be said that the memory electronically communicates with a processor if the processor read and/or write information for the memory. The memory may be arranged within a processor and also in this case, it can be said that the memory electronically communication with the processor.

The term “storage” may encompass any device which can permanently memorize data by magnetic technology, optical technology or non-volatile memory. For example, the storage may be an HDD, an optical disc, an SDD or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A network device comprising:
a receiver configured to receive a delivery reservation request of content from a first terminal in a coverage area of the network device;
a processor configured to select a first network device from among a plurality of other network devices on the basis of the delivery reservation request, the other network devices being wirelessly communicable with terminals in respective coverage areas; and
a transmitter configured to transmit a cache request to the first network device, the cache request instructing to acquire and cache the content from a content provision device; wherein
the transmitter transmits first information to the first terminal, the first information being information required to acquire the content from the first network device.

2. The network device according to claim 1, wherein
the delivery reservation request includes a terminal identifier of the first terminal; and
the processor selects the first network device on the basis of time of the delivery reservation request having been made by the first terminal and a location of the first terminal at the time of the delivery reservation request having been made.

3. The network device according to claim 1, wherein
the receiver receives the first information from the first network device after the cache request is transmitted; and
the transmitter transmits the first information received by the receiver to the first terminal.

4. The network device according to claim 1, wherein the first information has a value based on an identifier of the content and the terminal identifier.

5. The network device according to claim 1, wherein
the processor selects one or more second network devices in addition to the first network device and assigns a group identifier commonly to the first network device and the second network devices;
the transmitter transmits the group identifier to the first network device and the second network devices; and
the transmitter transmits the group identifier to the first terminal.

6. The network device according to claim 1, wherein
the receiver receives a cache request to instruct acquisition and caching of the content from the content provision device, from a third network device;
the processor acquires the content from the content provision device on the basis of the cache request and caches the acquired content in association with second information;
when receiving a content delivery request including the second information from a second terminal by the receiver, the processor identifies content related to the second information from at least one piece of cached content; and
the transmitter transmits the identified content to the second terminal.

7. The network device according to claim 6, wherein
the cache request includes a group identifier commonly assigned to the network device and at least one of other network device, and a device identifier of the at least one of the other network device;
the processor caches the acquired content in association with the group identifier included in the cache request;
the content delivery request includes a group identifier;
the receiver transmits an inquiry on whether the content related to the second information is held, to the other network device assigned the same group identifier as the group identifier included in the content delivery request, and acquires the content related to the second information from the other network device that holds the content; and
the transmitter transmits the content acquired from the other network device to the second terminal.

8. The network device according to claim 7, wherein the transmitter intermittently transmits the group identifier.

9. The network device according to claim 6, wherein the processor generates and activates an agent process for the second terminal on the basis of the cache request, and the activated agent process performs an operation of acquisition and caching of the content.

10. A wireless communication terminal comprising:
a transmitter configured to transmit a delivery reservation request of content to a first network device;
a receiver configured to receive first information required to acquire the content from the first network device after the delivery reservation request is transmitted; and
a processor configured to detect a second network device different from the first network device and perform control to wirelessly connect to the second network; wherein
the transmitter transmits a content delivery request including the first information to the second network device; and
the receiver receives the content corresponding to the first information from the second network device.

11. The wireless communication terminal according to claim 10, wherein
the receiver receives a group identifier from the first network device;
the transmitter transmits the content delivery request including the first information and the group identifier to the second network device; and
the receiver receives the content corresponding to the first information from the second network device.

12. A non-transitory computer readable medium having a program stored therein which causes a computer when executed by the computer to perform processing comprising:
receiving a delivery reservation request of content from a first terminal in a coverage area of a network device;
selecting a first network device from among a plurality of other network devices on the basis of the delivery reservation request, the other network devices being wirelessly communicable with terminals in respective coverage areas;
transmitting a cache request to the first network device, the cache request instructing to acquire and cache the content from a content provision device; and
transmitting first information to the first terminal, the first information being information required to acquire the content from the first network device.

13. The medium according to claim 12, the program further causing the computer to perform:
receiving a cache request to instruct acquisition and caching of the content from a content provision device, from a second network device; and
acquiring the content from the content provision device and caching the acquired content on the basis of the received cache request.
